(19) United States
(12) Patent Application Publication
(10) Pub. No.: US 2010/0036599 A1
(43) Pub. Date: Feb. 11, 2010

(54) SAFEST TRANSPORTATION ROUTING

(75) Inventors: Peter Froeberg, Cupertino, CA (US); Kenneth H. Levin, Lake Forest, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: RM Acquisition, LLC d/b/a/ Rand McNally, Skokie, IL (US)

(21) Appl. No.: 12/421,088

(22) Filed: Apr. 9, 2009

Related U.S. Application Data
(60) Provisional application No. 61/087,846, filed on Aug. 11, 2008.

(51) Int. Cl. G01C 21/00

(52) U.S. Cl. 701/200

(57) ABSTRACT

Methods and systems for determining a safest transportation route include determining a risk value for each of a set of candidate routes between an origin and a destination based on one or more safety factors or criteria, and comparing the risk values to determine the safest route. The risk values may be based upon default or selected safety factors, and may correspond to a normalized cost per unit distance. Safety factors may be derived from map data, obtained from user input and/or derived from other statistical data. User preferences and priorities may be included in the process for determining a safest route. Determined safest routes may be displayed, and may indicate especially risky portions of the determined safest route.

### RELATED APPLICATION

This application is a regularly filed application claiming priority to co-pending U.S. Provisional Application Ser. No. 61/087,846, entitled “Safest Transportation Routing” filed Aug. 11, 2008, the entire disclosure of which is hereby expressly incorporated by reference herein.

### FIELD OF THE DISCLOSURE

The present disclosure generally relates to navigation and routing systems, and more specifically, to methods and systems of determining a safest transportation route.

### BACKGROUND

Determining a transportation route using navigation or route evaluation systems has been commonplace for many years. Generally speaking, navigation or route evaluation systems may determine a route, e.g., a geographical route, over which a person or other transported entity may traverse, typically (but not necessarily) while driving or being transported in a motor vehicle. Websites, in-dash navigation systems, wireless phones and devices, portable navigation devices (PNDs) and the like use software to determine and provide directions for the route. These devices may use digital map data to determine an “optimal” route solution, which generally specifies a path from an origin to a destination based on specified criteria, most often related to the quickest or shortest route between the two locations using known roads or other pre-established transportation paths.

The specified criteria on which the optimal route is based may be indicated by a user. One commonly indicated criterion is a fastest route optimization, that is, a route judged by the navigation or routing system to take the shortest amount of time to traverse, e.g., drive, while obeying all legal regulations and posted laws such as speed limits, one-way streets, turn restrictions, etc. Other specified criteria for a route optimization may include, for example, shortest overall driving distance without regard to driving speed, fastest driving time without using freeways, fastest driving time without tolls, and fewest set of driving instructions, to name a few. Some routing options may allow a user to specify intermediate points (waypoints) to be included in the determined route. Determining a route for trucks and other large vehicles may take into account other criteria and factors that may affect navigability of such vehicles, such as truck-restricted segments, low overpasses, weight and cargo restrictions, avoidance of sharp turns, and the like. If no user indication of an optimization criterion is provided, a navigation or route evaluation system may default to a particular optimization criterion.

A route may be optimized to encompass modes of transportation that are not driven or operated by a user, such as routes that optimize the use of public transportation and/or routes that are modified to apply to pedestrians (e.g., pedestrians are not legally allowed to walk on highways, pedestrians are not subject to left-turn restrictions, etc.). Some navigation systems may include traffic delays and/or construction sites into their routing calculations, and may accordingly adjust expected travel speeds along roads in affected areas. Some navigation systems may also include options for determining non-motor vehicle transportation routes, such as routes for bicycles, skateboards, inline skates, and the like.

Current navigation systems, digital map data, routing systems and commercial roadway databases, however, do not provide a determination of a safest transportation route, that is, a route that has a minimum amount of risk. Current navigation systems, routing systems and commercial roadway databases also do not provide a way for a user to select a safest route that is tailored to the user's personal safety preferences.

### SUMMARY OF THE DISCLOSURE

The present disclosure describes methods and systems which determine a safest transportation route between an origin and a destination. In particular, a method or a system for determining a safest route may include obtaining indications of the origin and the destination, accessing map data to determine candidate routes, determining a risk value for each candidate route, and comparing the risk values of the candidate routes to determine the safest route. The risk values for each candidate route may correspond to a level of safety for each candidate route.

The present disclosure also describes embodiments of a method for determining a risk value for a route which may be used as, for example, a procedure in determining a safest route. The risk value may be determined based upon one or more safety criteria or safety factors, including physical route attributes, personal safety preferences, personal convenience factors, and other types of risk factors. Some of the safety criteria or factors may be selected by a user and/or may require additional user input. If desired, some of the safety criteria or factors may be determined by analyzing map data or other types of data and default or prioritized safety criteria or factors may be used. Still further, methods for interacting with a user and displaying safety factors for user selection that are to be used in determining a safest route are disclosed in detail.

The systems and methods disclosed herein may operate in a standalone mode or in conjunction with existing route evaluation or navigation systems and methods.

### BRIEF DESCRIPTION OF THE DRAWINGS

FIG. 1A is an architectural block diagram of an embodiment of a system that may be used to determine a safest transportation route and to implement the methods described herein;

FIG. 1B depicts an embodiment of the system of FIG. 1A using a web-based route evaluation system including a browser;

FIG. 1C depicts an embodiment of the system of FIG. 1A using a web-based route evaluation system including an installed application at a second computing device;

FIG. 1D depicts an embodiment of the system of FIG. 1A using a personal navigation device;

FIG. 2A illustrates an exemplary embodiment of a method for determining a safest transportation route between an origin and a destination;

FIG. 2B depicts an embodiment of the step of determining a candidate risk value for a candidate route from FIG. 2A;

FIG. 2C depicts another embodiment of the step of determining a candidate risk value for a candidate route from FIG. 2A;

FIG. 3 is an embodiment of a dependency chart that illustrates an exemplary set of safety factors on which a risk value may be based;

FIG. 4 depicts an embodiment of a method for determining the risk value for a route based on multiple safety factors;

FIG. 5 illustrates an embodiment of a method for obtaining user selections of safety factors and their relative importance;

FIG. 6A illustrates an example user interface that may be used to implement the methods and systems described herein;

FIG. 6B illustrates a modification to the screen from FIG. 6A that provides for indications of priorities;

FIG. 6C illustrates an exemplary screen related to the screen of FIG. 6A that provides for safety factor selection,

FIG. 7A illustrates an example of a screen displaying a textual representation of a determined safest route, and

FIG. 7B illustrates an example of a screen displaying a graphical representation of a determined safest route.

### DETAILED DESCRIPTION

Generally speaking, the methods and systems described herein determine a set of candidate routes between the origin and the destination, determine a risk value for each candidate route, and compare the risk values to find a “safest route” or path to be used in traveling from the origin to the destination. The risk value for each candidate route may be determined using or based on one or more different safety factors or safety criteria, such as physical route attributes, statistical data associated with the candidate route, personal safety preferences and/or personal convenience preferences. Some of the safety criteria may be obtained from one or more databases, such as from a database including map data or a database including statistical data. In addition, some of the safety factors or criteria relating to personal preferences may be obtained from user input and the user may prioritize the one or more different safety criteria to tailor the determination of the safest route to the user's preferences.

If desired, the user may prioritize optimizing route safety with respect to other available route optimizations, such as optimizing for a shortest time of travel, a least distance, an avoidance of highways, and the like. Moreover, the system may determine the safest route from multi-modal candidate routes, e.g., candidate routes that are traversable at least partially by more than one mode of transportation.

The methods and systems for determining a safest route may be performed in the context of systems which determine use conventional route determination methods. However, rather than optimizing for shortest travel time or shortest distance, the system may optimize for safety, based on a set of risks experienced in each candidate route. To illustrate this difference, consider an example of determining a safest route between two points, with two candidate route choices A and B. In this example, candidate route A is a 30 mile stretch of divided, four-lane interstate highway with four interchanges and a posted speed limit of 65 MPH. Candidate route B is a 20 mile stretch of two-lane rural highway with twenty-four intersections, no dividers or dedicated turn lanes, and a posted speed limit of 55 MPH. Statistically, rural highways have a higher accident rate than interstate highways due to factors such as lack of dedicated turn lanes, blind intersections, narrow lanes, and the like.

In a traditional shortest route determination, candidate route B will always be chosen because it is ten miles shorter than candidate route A. Likewise, in a traditional fastest route determination, candidate B will also be chosen because the travel time at 55 MPH is 21 minutes, 50 seconds whereas the travel time of candidate route A will take 5 minutes and 50 seconds longer.

In a safest route determination, however, candidate route A will usually be chosen. In particular, using an arbitrary unit of risk (for example, fatalities per million miles traveled), candidate route A may have an overall risk value of 0.32 units per mile while the overall risk value of candidate route B may have an overall risk value of 1.52 units per mile. Thus, the safest route to take is candidate route A as the total risk integrated over the 30 mile distance of the route is only 9.6, while candidate route B has a total risk of 30.4 when integrated over its 20 mile distance.

In the above example, risk values were expressed using a casualty cost per unit distance measure, i.e., fatalities per million miles. A “casualty cost,” as used herein, may be a cost generally indicating an amount of casualty to people and/or property, such as fatalities, injury, accident or loss. Other units may be used to determine and compare risk values. One example may be to assign risk value using a monetary cost, similar to an actuarial cost model used in the insurance industry. Another example of a risk value unit may be based on time. Of course, other units of comparison may be possible.

The safest route determination systems described herein provide advantages over existing navigation and route evaluation systems by quantifying a level of risk for candidate routes and determining a safest route between two or more points. While existing approaches seek to minimize attributes such as travel time, travel distance or number of instructions within a route, these existing approaches generally do not provide optimizations based on safety. The present systems and methods, on the other hand, may determine a route that minimizes risk, maximizes safety and helps a person to have a safe trip.

The methods of determining a safest route as described herein may be deployed in the context of various different architectural configurations of navigation or routing systems. For example, the methods or systems for determining a safest route may be entirely performed on a computing device, such as on a computer or on a portable or in-dash personal navigation device, which is local to the user. On the other hand, the safest route determination system may be web-based and be performed mostly at one or more web-site servers, peer computing nodes, or other computing devices, with only the user interface being locally situated with respect to the user. In this case, the locally situated user interface may be enabled to communicate with the web-site and may be, for example, a web browser on a computer, a PDA, a wireless device, or other computing device. In yet another example, methods or systems of determining a safest route may be deployed on a hybrid architecture, wherein route determination may be performed remotely at one or more web-site servers or other computer devices, while the user interface and the route display may be performed locally by a resident application at a local computing device. Of course, in addition to the aforementioned examples, other architectural embodiments of the methods and systems of determining and displaying a safest route are possible.

Before describing specific embodiments of a safest route determination system, a discussion of various terms used in this disclosure is in order.

A “mode of transportation” or “transportation mode,” is used herein according to its ordinary and customary meaning, that is, a manner or method of conveying people and/or goods. For instance, a transportation mode may include a mode of pedestrian ambulation, such as walking, running, or swimming. A transportation mode may be a motor vehicle classifiable by governmental agency, such as a personal car, a truck, a farm vehicle, a motorcycle, a bus, an airplane, and the like. A transportation mode may be a personal transportation device with or without a motor, such as skates, a skateboard, a bicycle, a unicycle, a canoe, a windsurf board, a Segway©, to name a few. A transportation mode may include public transportation or vehicles that operate in and/or on the water. A mode of transportation may be public or private, commercial or non-commercial.

A “route,” as used herein, is a geographical connection or path between an origin and a destination that is traversable by a mode of transportation, and that may be represented a priori on a map or by digital map data. Thus, in the instant disclosure, a highway, a designated hiking trail in a national park, a subway line and an access canal from a harbor to an ocean are examples of a route or parts thereof, but a path navigated in real-time through a variably changing crowd of people and cars in a parking lot is not an example of a route for the purposes of this disclosure. A route may be traversable over, for example, a paved surface, a gravel surface, a dirt path, a waterway, a public transportation line, a rail line, or some other type of surface.

A “route segment,” as used herein, is an identifiable portion of a route. Examples of a route segment may include a block on a street with a street name, a name of a body of water from one set of coordinates to another, a hiking trail name between two trail markers, a train line between two stops, a roadway, etc.

A “vehicle,” as used herein, is an entity that traverses a route. A vehicle may convey one or more people, goods or both. Examples of vehicles may include skateboards, skates, cars, trucks, buses, boats, subway trains, surface trains, elevated trains, etc. A single vehicle may be capable of one or more modes of transportation, for example, a person may walk or swim, and an amphibious vehicle (e.g., “Duck”) may navigate in the water or on a road. A vehicle may be public or private.

A “safety risk factor” or “safety criteria” for a route, as used herein, may be a factor or criterion that corresponds to an amount of or a type of risk encountered while traversing a route. An amount of risk generally increases as the probability of an accident, collision or other undesirable event occurring during traversal of the route increases. Route A may be considered “safer” than Route B if the probability of the occurrence of an accident or other undesirable event while traversing Route A is less than that while traversing Route B. For example, Route A may be “safer” than Route B if Route A has fewer intersecting roads than Route B, and thus a lesser chance of “T-Bone” accidents.

A “safer” route may also include a higher probability of a desirable, timely mitigation of an undesirable event. For instance, Route A may be considered “safer” than Route B if Route A has more complete cell phone coverage or if Route A has a higher density of service stations. A “safer” route may also include more characteristics desired by a user of a routing system, for instance, quality of lighting along the route or proximity to gas stations. The concept of “safety” and a “safer” route may vary from person to person. Accordingly, the present disclosure takes these differences into account, as will be detailed in subsequent sections below.

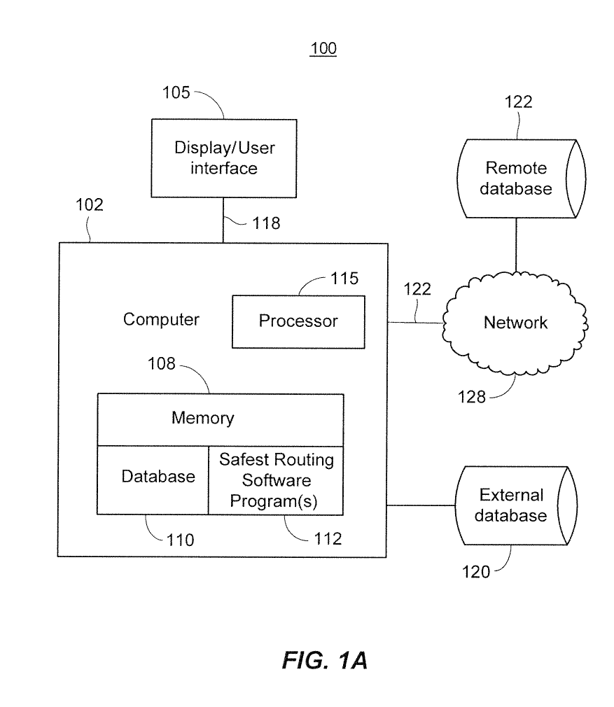

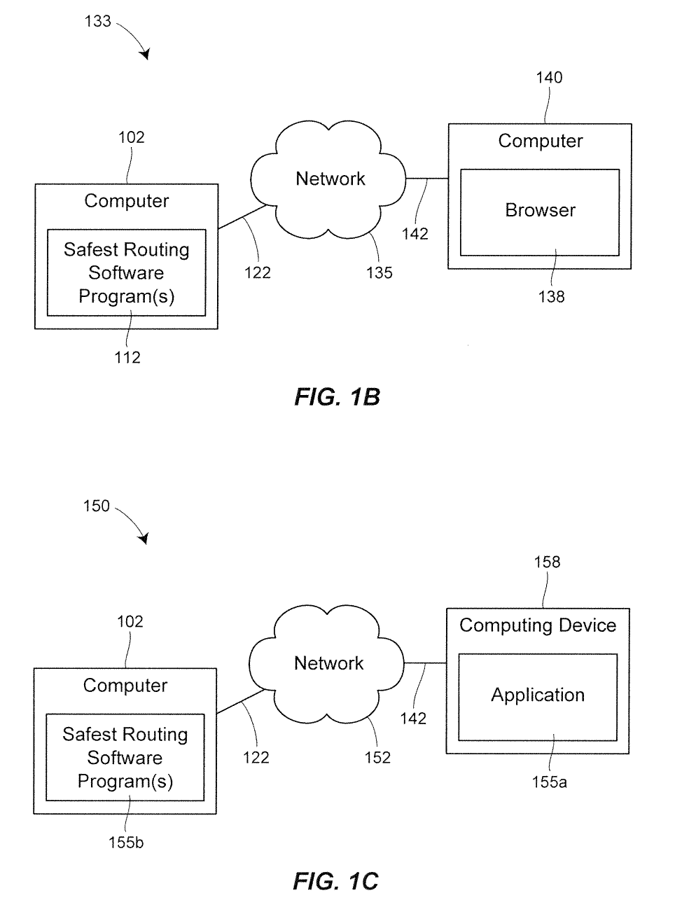

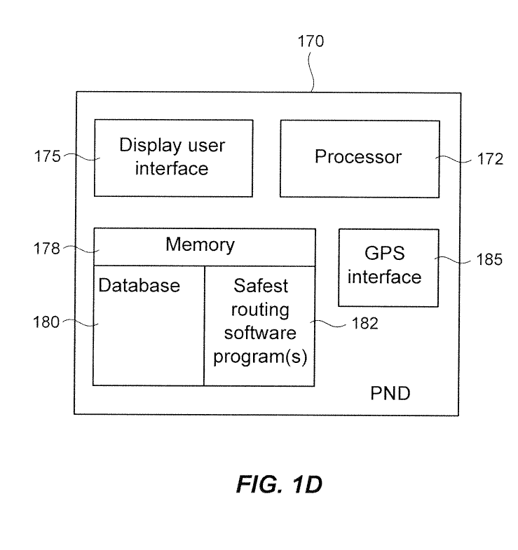

FIG. 1A illustrates an architectural block diagram of an example route evaluation system 100 for determining a safest transportation route. The route evaluation system 100 may generally include a computer 102 connected to a display/user interface 105. The computer 102 may have a memory 108 that contains a database 110 and one or more software programs 112. The one or more software programs 112, which are executable by a processor 115 of the computer 102, may accept user inputs via the display/user interface 105, and may access the database 110 to determine a safest route. The software programs 112 may perform any or all portions of the methods discussed herein for determining a safest route.

While performing any or all portions of the methods for determining a safest route using the software programs 112, the processor 115 of the route evaluation system 100 may access the internal database 110. Alternatively or additionally, the processor 115 may access the external database 120 in connection with the computer 102. The external database 120 may be, for example, a database on an external hard drive, a flash drive, an SD card, or other external memory device. Alternatively or additionally, while determining a safest route, the processor 115 may access the remote database 122 via the link 125 to the network 128. Although FIG. 1A depicts the databases 110, 120 and 122 each as a single database, in some embodiments, each reference 110, 120 and 122 may include more than one database devices.

The databases 110, 120 and/or 122 each may include digital map data from a commercial or proprietary map database. Likewise, some or all of the databases 110, 120 and/or 122 may provide additional map data not included in a commercial map database. The digital map data retrieved from the databases 110, 120, and/or 122 may include, but is not limited to, geodetic street coordinates, associated shape geometry, road class, lane count, lane width, and other physical attributes of roads, paths, routes and/or route segments, as well as legal regulations associated with the roads, paths and routes (e.g., one-way designations, speed limits, access and turning restrictions, etc.).

Moreover, in addition to the digital map data, the databases 110, 120 and/or 122 may each include one or more other databases or otherwise digitally stored information required to be accessed by the methods of the disclosure. This information may include, for example, statistical data such as cellular phone coverage maps, weather information, area crime, climate, weather information, Federal Highway and/or other organizations' accident statistics and number of tickets issued, frequently updated construction status maps, maps including locations of rest stops, restaurants, service stations, retailers and other such amenities, public transportation maps, topographical maps, water current maps, and other such information.

In FIG. 1A, the link 125 to the network 128 may use wired or wireless technology. The network 128 may be a local area network, a wide area network, the Internet, a peer-to-peer network, or other type of network. The network 128, which may be public or private, may provide access to the remote database 122 located on another computing device. Any known type of network 128, link 125 and remote database access mechanism may operate in accordance with the route evaluation system 100. The network 128 may provide access to other computing devices. In fact, in some embodiments, the communication link 118 may be the same link as the link 125. In some embodiments, multiple links 125 to multiple networks 128 may be possible.

The route evaluation system 100 may be embodied on any platform commonly employed for navigation and routing systems. For example, FIG. 1B illustrates an embodiment of the route evaluation system 100 implemented as a web-based route evaluation system 133, such as when a user visits a web-site to obtain safest routing directions without downloading any application software to the user's computing device. In the web-based system 133, the computer 102, for example, may host the route evaluation website. The computer 102 may include, inter alia, the safest routing software program(s) 112 and the computer 102 may be linked by the link 122 to a network 135 operating in conjunction with or across the Internet. The network 135 may be, for example, a client/server network, a peer-to-peer network, or any other type of network. The network 135 may be public, private or a combination of public and private. Thus, the computer 102 may represent at least one computing element in the network 135, such as a server or a peer node. In the web-based route evaluation system 133, the display and user interface 105 shown in FIG. 1A may be provided via a browser 138 that may visit web sites accessible via the network 135. The browser 138 may reside on a computing device 140 other than the computer 102 (e.g., the user's computing device) such as a conventional computer, a PDA, a cell phone, a wireless device or any electronic device and may be in communication with the safest routing software program 112. The browser 138 on the computer 140 may be in communication with the safest routing software program(s) 112 on the computer 102 via a wired or wireless connection 142 to the network 135.

Another embodiment of the route evaluation system 100 may again be a web-based system 150, such as illustrated in FIG. 1C. The web-based system 150 may be used, for example, when a user visits a route evaluation web-site to determine a safest route, but the route evaluation web-site requires a local software download to the user's electronic device in order for the routing programs to execute. Similar to FIG. 1B, the computer 102 may, for example, host the route evaluation web-site. The computer 102 may be linked by the link 122 to a network 152, such as the Internet or any other public network, private network, or direct connection. Also, the computer 102 again may represent one or more computing entities of the network 152, such as one or more servers, one or more peer nodes, or one or more computing entities operating in conjunction with any other types of network technology. In FIG. 1C, however, rather than using a browser for the display and user interface 105, the display and user interface 105 may be handled by a client or peer application 155a executing directly on a user's electronic device 158 (e.g., a conventional computer, a PDA, a cell phone, wireless device, or any other such electronic device). The user's electronic device 158 may access the network 152 via a wired or a wireless link 158, and the resident application 155a at the user's electronic device 158 may be in communication with safest routing software program(s) 155b at the computer 102 via the network 152. Thus, in this web-based route evaluation system 150, the functionality of the safest routing program(s) 112 of FIG. 1A may be divided (155a, 155b) across at least two separate computing entities (102, 158) and may communicate with each other over the network 152.

Another embodiment of the route evaluation system 100 may be a personal navigation device (PND), such as the example PND 170 illustrated in FIG. 1D. Generally, the PND 170 may be a computing entity primarily dedicated to personal navigation or routing. The PND 170 may be built into a vehicle or other receiving entity, or the PND 170 may be portable. The PND 170 may include a processor 172, a display or user interface 175, and a memory 178 including a database 180 and computer-executable instructions for performing safest route determination 182. Digital map and other necessary databases accessed by the route application may be locally stored in the database 180. Some or all of the safest route calculations may be performed by the software programs 182 using the local database 180, and the resulting safest route may be displayed on the user interface 175. The database 180, the software programs 182 and other temporal data may or may not be periodically updated via an update interface (not shown), or may be periodically updated by loading a new version of the software program 182 and/or the database 180 into the memory 178 of the PND 170. In some embodiments, the PND 170 may also include a GPS interface 185 for determining a location of the PND device 170.

Yet another embodiment of the route evaluation system 100 may include a stand-alone route application entirely installed on the computer 102, for example, as a part or all of the software programs 112 of FIG. 1A. The stand-alone application may be, for example, purchased or otherwise obtained by a user for installation entirely and directly on the user's electronic device. In this embodiment, the computer 102 may be, for example, a personal computer, a wireless communication device, a cell phone, a PDA, or any such general multi-purpose computing device. The display and user interface 105 may be the display/user interface 105 of the computer 102, such as a screen, keyboard and mouse associated with the computer 102. Digital map and other necessary databases accessed by the route application may be locally stored in the database 110 or may be stored in a database 120 external to the computer 102. Additionally or alternatively, digital map and other necessary databases may remotely located 122 from the computer 102 and may be accessed by the one or more software programs 112 via a link or a connection 125 to a network 128. Periodic updates to the software program 112 and/or to the databases 110, 120, and 122 may occur.

The above embodiments of the route evaluation system 100 are exemplary and are not meant to provide a comprehensive list. Other embodiments of the system 100 may be possible. The main differences between various embodiments of the system 100 are largely architectural and relate to where the safest route is calculated, where it is displayed, and where the underlying risk models, map data, and other data are maintained. Embodiments of the system 100 of FIG. 1A may operate in accordance with any of the methods and systems described in this disclosure.

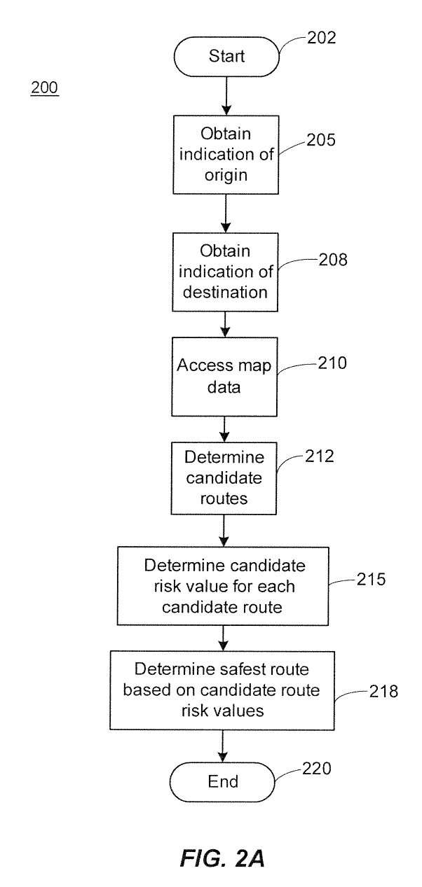

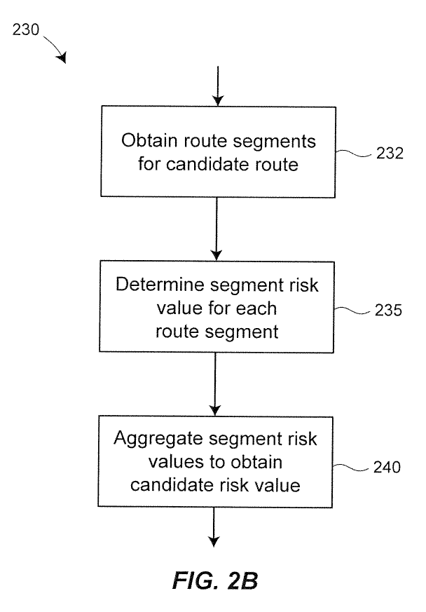

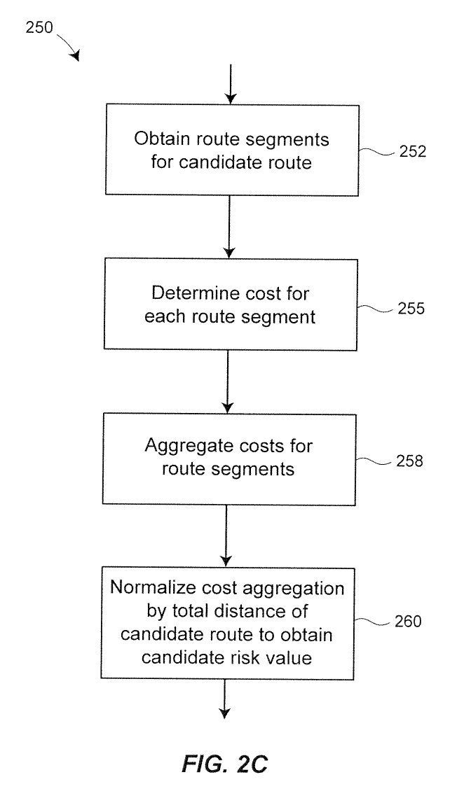

FIG. 2A illustrates an exemplary method 200 of determining a safest transportation route between an origin and a destination. The method 200 may be partially or totally performed by the one or more software programs 112 of FIG. 1A. In fact, embodiments of the method 200 may operate in accordance with embodiments of the route evaluation system 100 of FIG. 1A.

At the start (block 202) of the method 200, an indication of an origin may be obtained (block 205). The indication of the origin may be obtained, for example, via the input of a user at a navigation system or any other architectural configuration of a routing system that executes the method 200, for example, route evaluation system 100 of FIG. 1A. At a block 208, an indication of a destination may be obtained. The indication of the destination may be obtained via a same or different mechanism used for obtaining the indication of the origin.

At a block 210, map data may be accessed. Map data may typically, but not necessarily, be in a digital format. Map data may be accessed from a single database or from multiple databases and may be accessed directly or remotely. The map data may be accessed via a database query, a protocol, a message exchange, accessing a website, use of metadata, or any other known method of accessing data. The map data may include the indication of the origin and the destination, as well as an indication of one or more route segments between the origin and destination. Map data may include a type of a road, path, route or route segment, its name or identification, a geometrical and geographical representation of the route or route segment, and other attributes associated with the route or route segment that are commonly included in map data. Map data may also include any legal regulations associated with route segments, e.g., speed limits, restrictions such as for height, weight, and/or type of vehicle, one-way designations, and the like. In fact, any map data known in the art may be used in conjunction with the method 200.

At a block 212, one or more candidate routes between the origin and the destination may be determined from the map data. Each candidate route may include a geographical connection, a path, or a traversable route composed of a sequential, contiguous ordering of one or more route segments between the origin and the destination.

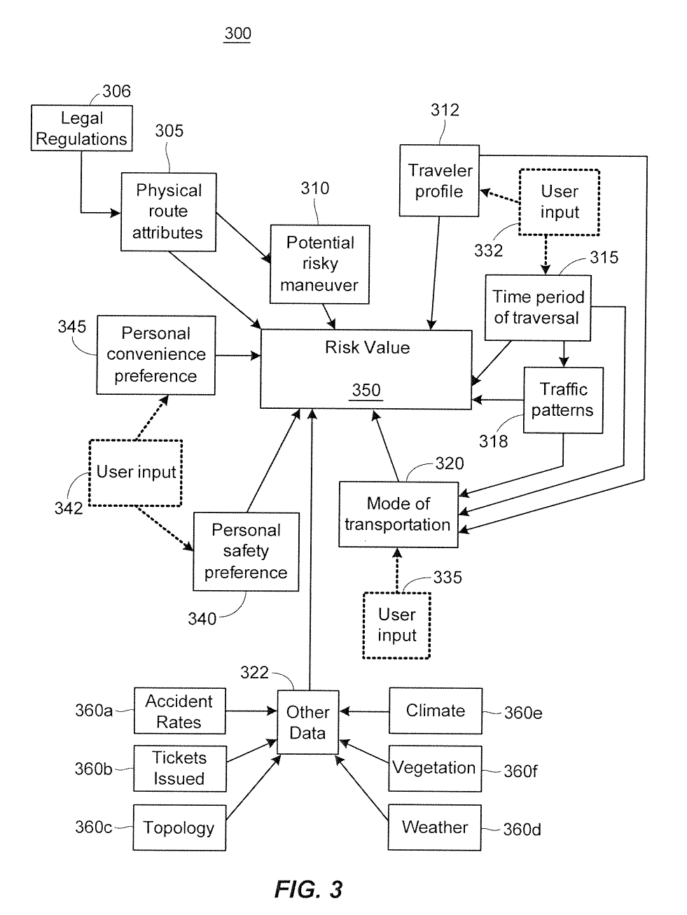

Continuing with the method 200, at a block 215, a risk value for each candidate route may be determined. A risk value of a route may correspond to a level of safety for the route, and may be based on one or more safety criteria or safety factors. An exemplary set of these safety factors is illustrated in FIG. 3, and will be explained more fully in the detailed description of FIG. 3. A “safest route” may mean different things to different people, and accordingly, the specific dependent safety criteria or factor(s) on which the risk value is based may indicate a context of safety to be used in assessing the “safest” route. The block 215 may determine the risk value for each candidate route based on one or more specific safety factors or criteria.

The step of determining the risk value for each candidate route depicted by the block 215 may be performed in any number of ways. For example, FIG. 2B illustrates one possible detailed embodiment 230 of determining the risk value for a particular candidate route 215. The method 230 may include obtaining route segments for the particular candidate route 232. A route segment may be obtained based on geography, such as a portion of a route connecting two intersecting streets, or a route segment may be obtained based on another criteria, such as a portion of the route with a speed limit over 55 miles per hour. At block 235, a segment risk value for each route segment may be determined. Each segment risk value may be determined by a same set of safety factors, but in some cases, different safety factors may be used (such as when a particular safety factor only applies to a particular route segment). At block 240, the risk values of the route segments of the candidate route may be aggregated to determine an overall risk value for the candidate route. The aggregation may be a simple sum or a weighted sum. In some embodiments, one or more other aggregation algorithms may be used to determine the candidate risk value.

FIG. 2C illustrates a different detailed embodiment 250 of determining the risk value for a particular candidate route 215. The method 250 may include obtaining route segments for the particular candidate route 252. Next, the method 250 may determine a cost for each route segment (block 255). The cost may be expressed in monetary terms similar to an actuarial cost model used in the insurance industry. For instance, the actuarial cost model may express the cost in terms of dollars or other monetary units, and may incorporate factors into the monetary model such as probability of accidents, fatalities, and any resulting monetary costs. Other cost models may express the cost in other units, such as, for example, a cost model based on time, a casualty cost model for people and/or property, and the like.

In some embodiments, the cost may be expressed in a combination of units. For example, if a courier must deliver a transplant organ for a critical patient surgery, the courier may wish to minimize a chance of accident as well as minimize a total time of travel. Here, a combination of two different cost units may be used (accident cost and time cost). Some embodiments may allow for a default cost unit while other embodiments may allow for combining types of cost units.

Continuing with the method 250, the costs for more than one route segment of the particular candidate route may be aggregated (block 258). The aggregate cost may be determined by using a simple sum, a weighted sum or some other algorithm of aggregation. At block 260, the aggregate cost for the candidate route may be normalized by a distance of the particular candidate route to obtain the candidate risk value for the particular candidate route. Accordingly, in this embodiment 250, the candidate risk value for the particular candidate route may be expressed in a measure of cost per unit distance. Using a cost per unit distance measure may allow candidate risk values across considered candidate routes to be easily compared.

Of course, the method 230 of FIG. 2B and the method 250 of FIG. 2C are exemplary. Other methods of determining the overall risk value for a candidate route 215 may also be possible and may operate in accordance with the method 200 of determining a safest route.

Turning back to FIG. 2A, at a block 218, the safest route may be determined by comparing the risk values for each of the candidate routes between the origin and the destination. The safest route may be determined as the candidate route having a risk value corresponding to the highest level of safety among the potential candidate routes. Finally, at a block 220, the method 200 may end.

Embodiments of the method 200 may use multiple safety criteria or safety factors to determine a risk value for each candidate route (block 215). FIG. 3 illustrates one possible example of a dependency chart 300 showing an exemplary set of safety criteria or safety factors 305, 310, 312, 315, 318, 320, 322, 332, 335, 340, 342, 345 on which a risk value 350 may be based. The dependency chart 300 is not meant to be comprehensive in defining the complete set of safety criteria or factors on which the risk value 350 may be based, but merely provides an illustrative set of safety factors (305-345) and their possible dependency based inter-relationships. The dependency chart 300 may be used in conjunction with any embodiments of the methods and systems of the disclosure. Embodiments of the dependency chart 300 may be used, for example, with embodiments of the system 100 of FIG. 1A or the method 200 of FIG. 2A.

In one embodiment of the dependency chart 300, the risk value 350 may depend on a single safety factor or criterion, such as one of the blocks 305-345. The single safety factor may be selected a priori or in real-time by a user, or a default single safety factor may be provided and used to determine the risk value 350.

In another embodiment, the risk value 350 may depend on multiple safety factors or safety criteria, for instance, using two or more of the blocks 305-345. One or more of the multiple safety criteria on which the risk value 350 depends may be selected a priori or in real-time by a user. Alternatively or additionally, one or more of the multiple safety criteria may be provided as a default. An indication of a user's preference for a specific safety criterion may or may not override the default status of that specific safety criterion.

In an embodiment having multiple safety factors on which the risk value 350 depends, an ordering of importance of some or all safety factors may be obtained (for example, from a user or from stored data) and may be used in determining the risk value 350. For example, the ordering of importance of some or all safety criteria may correspond to a relative weighting of the safety factors or criteria. The overall risk value 350 may then be determined based on an aggregation of the relative weighting. The ordering of importance and/or the relative weighting of some or all of the safety criteria 305-345 may be selected a priori or in real-time. In some embodiments, some or all of the ordering of importance and/or the relative weightings for individual safety criterion may be provided with default values. A user's preference of the ordering of importance may or may not override a default value.

Turning now to a discussion of the various safety factors or safety criteria themselves, one possible safety factor on which the risk value 350 for a route may depend may be physical route attributes 305 of the route. Physical route attributes 305 may increase a probability of collision or accident on the route, thus influencing the risk value 350 and hence a safety level of the route, as will be explained below.

One category of physical route attributes 305 affecting the safety level of the route may be geometrical route attributes, e.g., a geometrical characteristic of a physical configuration or arrangement of the route. Geometrical route attributes may include, for example, road or path curvature, number and types of intersections, size, dimensions and other such geometrical characteristics. Indeed, the geometry of the number and types of intersections alone may have many characteristics that may increase the chance of accidents. For example, if candidate route A has a greater number of intersections than candidate route B, then the chance of accident on route A is greater than that of route B. If candidate routes A and B both have the same number of intersections but candidate route B has a particular intersection that has a severely skewed angle between the intersecting roads, then the chance of accident on candidate route B is greater than that of candidate route A. Other geometrical intersection attributes may also influence the chance of accident on a route, including a type of intersection (e.g., big street crossing a small one, small street crossing a big street, etc.), a presence of a blind intersection, a number of lanes in each of the intersecting streets, etc.

In addition to geometrical intersection attributes, other geometrical route attributes may also influence potential collision or accident probability. For example, unexpected curves with poor sight distances may increase the probability of an accident. A steep grade may increase the probability of an accident due to highly varying speeds of different vehicles and increased passing of slower vehicles. Other geometrical route attributes such as narrow lanes, the lack of dedicated left-turn lanes, the lack of shoulders, and the like each may affect the probability of collision or accident on the route. On routes that traverse highways, other geometrical route attributes such as short entry and exit ramps, insufficient distance between interchanges to allow safe merging, etc. may each play a role in affecting the chance of accident.

Geometrical route attributes may be calculated or determined using one or more digital map data databases, such as the map data accessed at the block 210 of the method 200. Alternatively, geometrical route attributes may be obtained directly from one or more other databases that may contain pre-calculated geometrical route attributes derived a priori from a digital map database or otherwise obtained and stored in the one or more other databases.

Physical route attributes 305, however, may not be limited to only geometrical route attributes. Other route attributes corresponding to a route or geographical area of a route may also play a role in risk assessment. An exemplary (but not comprehensive) list may include other route attributes such as:
Road composition (e.g., gravel, paved, etc.)
Road usage (e.g., interstate, state highway, local road, etc.)
Presence and dimensions of a tunnel or bridge
Bridge strength
Grade of roadway (e.g., mountain pass, flat valley road, etc.)
Whether or not the road is divided
Presence of railroad crossings
Shoulder presence and shoulder widths
Number of passing opportunities
Presence of a controlled access
Presence of a recovery area or an emergency pull-off
Mix of newer four-lane stretches interrupted by two-lane stretches
Accessibility (e.g., wheel-chair accessible, able to be navigated by a person with impairments, etc.)
Dimensions of a water channel, such as depth and width
Marked or unmarked water channels
Presence and dimensions of manmade breakwaters
   These examples as well as other types of the physical route attributes 305 may be obtained and/or calculated from a same database as used to obtain the geometrical route attributes, they may be obtained and/or calculated from a different database, or from multiple different databases. For example, the geometrical route attributes may be calculated from digital map data, and updated shoulder presence and widths may be obtained from a real-time roadway construction status database. Physical route attributes 305 may thus influence determining the risk value for the route and, in turn, the safety level of the route.

A safety factor that may influence the physical route attributes 305 may be legal regulations 306. Legal regulations may include, for example, posted speed limits, one-way designations, weight, height or vehicle type restrictions, etc. for one or more segments of the route. One or more legal regulations may modify the effect of one or more physical route attribute safety factors 305 on the risk value 350. For instance, a two-lane highway with a posted 55 mph speed limit may be more risky than a two-lane highway with a posted 40 mph speed limit, or a left turn onto a one-way road segment may be less risky than a left turn onto a two-way road segment.

Another safety criterion or safety factor on which the risk value 350 may depend is a potential risky maneuver 310 associated with a traversal of the route. The potential risky maneuver 310 may be (but is not necessarily required to be) determined from the physical route attributes 305 of the route and, thus may be determined based on digital map data, as illustrated by the dependency arrow originating at the block 305 and ending at the block 310. For instance, a particular route that traverses a segment of a rural highway may require a potential risky maneuver due to a general lack of dedicated left turn lanes on rural highways. In this case, the particular route that traverses the segment of the rural highway may be more risky if the particular route demands a left turn maneuver from the rural highway onto another road. However, the reverse maneuver—a right turn maneuver from the rural highway—may be quite safe. Thus, the potential risky maneuver 310 may be determined not only by assessing the physical route attributes 305, but also by assessing what specific maneuvers are required during the traversal of the route between the origin and the destination. Other risky maneuvers may include U-turns, sudden decreases in speed or stops, etc.

Another safety criterion on which the risk value 350 may depend may be a traveler profile 312. The traveler profile 312 may include parameters such as traveler age, experience in operating a vehicle to be used on the route (such as operating, for instance, a car, a truck, a boat or other vehicle), familiarity in using a mode of transportation to be used on the route (such as, for example, using a subway, a bus or a train route), attributes of the traveler (e.g., uses a wheelchair or pulls rolling luggage, is visually impaired, is hearing impaired, etc.), and/or other parameters that may profile or describe attributes of the traveler. For example, an inexperienced driver may be more likely to be at risk in situations where driving judgment comes into play, such as when merging onto a freeway. On the other hand, an elderly driver may be more at risk in situations that require better visual acuity. In another example, a traveler that uses a wheelchair may require a route that has accessible public transportation or intersections having pedestrian walk signals to maximize safety.

Parameters of the traveler profile 312 may be obtained via a priori or real-time user input (e.g., via block 332 of FIG. 3), or default parameters for the traveler profile 312 may be provided. Similarly, an optional weighting of the parameters of the traveler profile 312 may be obtained via a priori or real-time user input (e.g., via block 332 of FIG. 3), where the optional weighting may correspond to a relative importance of parameters. Note that the traveler profile 312 is one criterion of the set of safety criteria or factors illustrated in dependency chart 300 that is easily and more likely to be combined with other safety factor(s) in determining the overall risk value for the route.

Another safety factor or safety criteria that may be used to determine the risk value 350 of the route may be a time period of traversal 315 of the route. For instance, a specific route that brings a traveler through Long Island on a weekday may be more risky at 2:00 am, but not as risky at 7:00 am. A different route near a grammar or middle school may be more risky during the start and end of the school day. The time period of traversal 315 for a particular route or route segment may be obtained a priori, may be obtained via real-time user input (e.g., at the block 332), or may be calculated based on a start time of a trip and other route segments over which a user will travel prior to reaching the particular route segment. The time period of traversal 315 may correspond (but is not necessarily required to correspond) to the physical route attributes 305 and/or the potential risky maneuvers 310. For example, a highway with a short distance between two specific interchanges may back up during rush hour and make merging more risky, but may be easily and more safely traversed on the weekends or during non-rush hours.

Traffic patterns 318 associated with the route or the route segment are related to a time period of traversal 315 and may be a safety factor or criterion that may affect the risk value 350 of the route. Traffic patterns 318 may be time-dependent, as illustrated from the dependency arrow originating at the block 315 and terminating at the block 318. An example of such a time-dependent relationship is the traffic patterns during rush hour periods and during non-rush hour periods of the aforementioned highway with the short distances between interchanges. Some traffic patterns 318 of the route, however, may be time independent with regard to determining the risk value 350. For instance, the traffic pattern at the “Hillside Strangler” in the Chicago metropolitan area had, at one point in time, at least seven lanes of traffic merging into three. An alternate route that requires less merging is always less risky than the Hillside Strangler at any time of day or night.

Another safety factor or safety criterion on which the risk value 350 of the route may depend is a mode of transportation 320 for the route. For example, generally speaking, flying on a commercial aircraft is statistically safer (with “safe” in this example being defined as the probability of an occurrence of an accident) than driving a personal automobile. Driving on a four-lane road without a sidewalk may typically be safer than walking on the shoulder of the four-lane road. The mode of transportation 320 may be selected by a user (as illustrated by block 335) or may be provided by a default (e.g., default to using a car). Likewise, the specific type of vehicle used in a particular mode of transportation may effect the risk value 350. For example, different risk values may be associated with traversing a road using a surface vehicle for different types of surface vehicles. Thus, a gravel road may be very dangerous for a motorcycle, but less dangerous for a car and even less dangerous for a four wheel drive vehicle.

Indeed, in accordance with the disclosure, the risk value may not be limited to being influenced by a single mode of transportation. Multi-modal transportation 320 may be selected. For instance, a user may select (via the block 335) to optimize use of public transportation on the route, and may additionally specify using a bicycle or a skateboard for those route segments that cannot be traversed by any mode of public transportation. In another example, a safest route from a bar may include walking and taking a train during the day, but may include a cab and taking the train at night. For multi-modal transportation routes, the risk value for each individual route segment may be determined based on the available or desired mode of transportation 320 to be used for each individual segment. The overall risk value 350 for the route based on a mode of transportation 320 safety factor may then be determined from an aggregate of the individual segment risk values. In addition to the mode of transportation 320 safety factor, multi-modal transportation modes 320 may be dependent on other safety criteria and factors, such as (but not limited to) the time period of traversal 315, traffic patterns 318, the traveler profile 312, and other safety criteria and safety factors.

While some elements of risk for the route may be calculated or inferred by the geometry and physical attributes (at the block 305) of the route, not all elements of risk may be so derived. Other elements of risk may be based on statistical data 322 associated with the route or segments thereof. For example, there is a road near White Sands, N.Mex. which is particularly dangerous to drive, yet it lacks most all of the known risky physical route attributes. The road is very straight, has few intersections, and the weather in New Mexico provides for some of the best year-round driving conditions. Nonetheless, two other factors make this stretch of road very dangerous—excessive speed and alcohol. The dangerousness of this stretch of road may be inferred from statistical data 322 such as accident rates 360a and/or tickets and warnings issued 360b.

Other statistical data 322 associated with the route may include factors involving topology 360c, weather 360d, and/or climate 360e. For example, a road that crosses high mountain altitudes may have limited lines of sight and be more prone to ice and snow, and therefore be considered as more risky than a straight road that passes through a desert with no weather or topology-related considerations. A sailing passage that crosses through an area with a known strong local wind (e.g., Abroholos wind, Bayamo wind, etc.) may have increased risk. Other statistical data 322 may include, for example, the presence of vegetation 360f. A winding, heavily tree-lined road may have poorer sightlines during the summer due to dense foliage, but may have better sightlines (and therefore be less risky) in the winter when the leaves have dropped.

Thus, statistical data 322 for the route may provide additional influence on the risk value 350. Typically, but not necessarily, the statistical data 322 may be obtained from one or more databases different than the database(s) that hold the digital map data. For example, accident statistics may be obtained from a database managed by a traffic agency, and weather information may be obtained from a different database managed by a weather service agency. Various types of statistical data 322 may be combined to influence the risk value 350 of a route. Consider the aforementioned example of the winding, heavily tree-lined road. Although the foliage in the winter vs. the summer may influence the risk value 350, the risk value 350 may also need to take into consideration the local climate. For example, traveling a winding, heavily tree-lined road during a northern Minnesotan winter may have a different risk value than traveling a winding, heavily tree-lined road during the winter in Missouri even though in both cases, the leaves have dropped from the trees. Of course, the types of statistical data 322 discussed herein are merely an illustrative set. Other types of statistical data 322 may be possible.

The concept of safety, however, may not be limited to minimizing the chance of accident or collision. The concept of safety may vary from person to person, and may incorporate personal safety preferences 340. For instance, if a driver's vehicle is not very reliable, the driver may feel safer if the route has adequate cellular phone coverage and is close to one or more vehicle repair centers. To a driver who is comfortable with making minor car repairs or has a more reliable car, a proximity to periodic repair centers may not be as important in selecting a “safest” route, but instead the driver may place more importance on area crime statistics so that the driver minimizes the chance of theft or attack while stopped along the route. Personal safety preferences 340 may be selectable, may be prioritized with respect to importance, and may include one or more attributes such as:
cellular phone (or other type of communication) coverage,
“remoteness” of the route (for example, as determined by the density of POIs (Points of Interest) associated with the route, or as determined by some other measure),
area crime statistics,
proximity to a vehicle repair facility,
quality of lighting (may be more important for older drivers or for drivers who are traveling at night in unfamiliar areas), or
existence of a hazardous break down locale (i.e., a segment of a route where a breakdown may be especially hazardous, such as, for example, a bridge, a tunnel, mountainous roads, a road with narrow shoulders, etc.).
   Of course, many other types of personal safety preferences exist and may be used in determining the risk value 350 of the route.

As represented by the block 342 in FIG. 3, a user may indicate a preference and/or a priority of personal safety preferences 340. In some embodiments, a default set of personal safety preferences 340 and (optionally) a priority of importance amongst the default set of personal safety preferences 340 may be provided and or stored for a user. A particular default personal safety preference may be overridden by an indicated user preference.

For some people, the concept of “safety” may include personal convenience preferences 345. For instance, a diabetic driver may wish to choose a safer route where the diabetic driver is able to reliably purchase food along the way. A person transporting an elderly passenger may require a safer route that has accessible rest room facilities spaced at closer intervals. Similar to personal safety preferences 340, individual personal convenience preferences 345 may be able to be selected and prioritized. Examples of personal convenience preferences 345 may include, for example, a proximity of the route or route segments to service stations, restaurants, rest stops, retailers, vehicle dealerships and handicapped-accessible facilities, to name but a few.

As represented by the block 342 in FIG. 3, a user may indicate a preference and/or a priority of personal convenience preferences 345. In some embodiments, a default set of personal convenience preferences 345 and/or a priority of importance amongst the default set of personal convenience preferences 345 may be provided. A particular default personal convenience preference may be overridden by an indicated user preference.

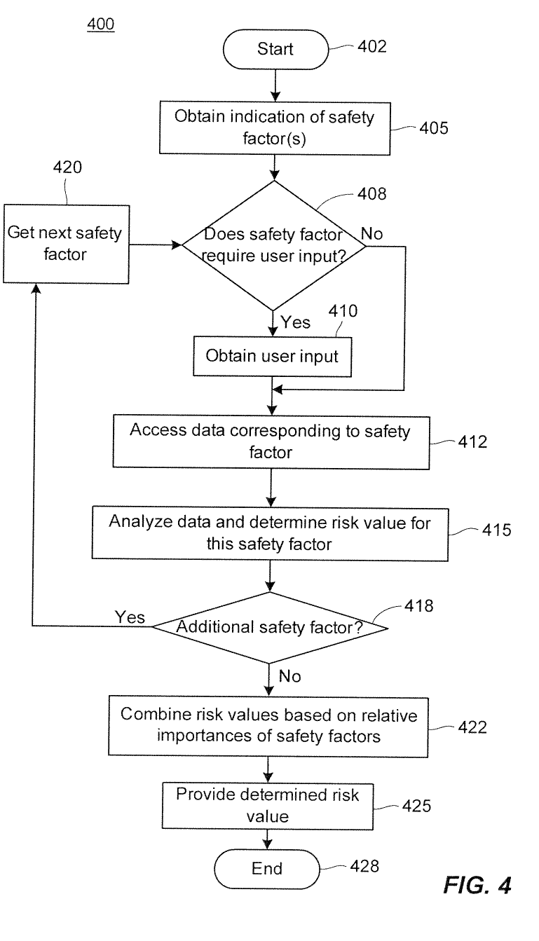

Turning now to FIG. 4, FIG. 4 depicts an embodiment of a method 400 for determining the risk value for a route based on multiple safety factors. Embodiments of the method 400 may operate in accordance with embodiments of system 100 of FIG. 1A, method 200 of FIG. 2A, and/or embodiments of dependency chart 300 of FIG. 3.

After a start point 402, a block 405 may obtain an indication of one or more safety factors to be used in determining a risk value of a route. In some embodiments of the method 400, the indicated safety factor(s) may be obtained from a stored, default safety factor. In some embodiments of the method 400, the indicated safety factor(s) may be obtained by user selection, real-time data user input, a previously stored user preference, or by some combination of the aforementioned or other options.

If, at a block 408, the indicated safety factor is determined to require a user input, the user input may be obtained at a block 410. Examples of safety factors that may require user input may include, for example, the traveler profile 312, the time period of route traversal 315 (or at least a time of a start of a journey), one or more preferred modes of transportation 320, personal safety preferences 340, and/or personal convenience preferences 328, all of which were previously discussed with respect to FIG. 3. In some embodiments of the method 400, user input may be obtained at the block 410 via a real-time interaction with a user. In other embodiments, user input for various safety factors may have been obtained and stored prior to the execution of the method 400. In these embodiments, the block 410 may retrieve the stored user input from a memory or other storage location.

After the required user input has been obtained (at the block 410), or if user input was not required (as determined by the block 408), the method 400 may proceed to block 412. At the block 412, data corresponding to the safety factor may be accessed and obtained. For example, if the indicated safety factor is related to the physical route attributes 305, digital map data may be accessed to analyze route geometry and to obtain other physical attributes of the route or route segment(s). In another example, if the indicated safety factor includes or uses statistical data 322, one or more appropriate databases may be accessed, for example, accident statistics or historical weather information. The block 412 may access multiple different databases in order to obtain all the required information corresponding to an indicated safety factor. For example, if the indicated safety factor is related to cell phone coverage for the route, access to both a digital map database and to a separate cellular coverage map may be necessary. The block 412 of the method 400 may employ any known local or remote data access mechanism, such as reading from a local or remote database, message exchange, open or encrypted protocols, use of metadata, and the like. Likewise, the block 412 may access a local or a remote database using any local or remote, wired or wireless, public or private network.

Next, at a block 415, the accessed and obtained data (and other potentially required data) may be analyzed to determine a risk value corresponding to the indicated safety factor for the route. In some embodiments of the method 400, analyzing of the data 415 may include actual calculations. For example, in an embodiment where the indicated safety factor is based on the physical route attributes 305, route geometry may be first obtained by the block 412, and then the block 415 may then algorithmically analyze the obtained route geometry data to identify any risky geometrical attributes such as degree of curvature, number and types of intersections, etc. In another embodiment, instead of accessing route geometry data 412 in the form of raw digital map data, the data accessed by the block 412 may be accessed in a preprocessed form, where some level of analysis of risky geometrical attributes has already been performed and stored. In this embodiment, the block 415 may need to perform less analysis to determine a risk value for the route associated with the indicated safety factor.

Block 418 may determine if any additional safety factors are indicated. If there are additional indicated safety factors to be considered, a block 420 may obtain the next indicated safety factor, and the method 400 may return to the block 408. If, at the block 418, all of the indicated safety factors have been considered for the route, the method 400 may proceed to block 422.

At the block 422, the risk values for the route based on the indicated safety factors may be combined to determine an overall risk value for the route. In some embodiments, this combination may be determined based on a relative importance of the indicated safety factors with respect to each other. The relative importance amongst indicated safety factors may influence how corresponding individual risk values are combined, such as by using a weighting scheme or other type of algorithm.

The relative importance of various indicated safety factors may be obtained via user input in real-time, for instance, while in conjunction with obtaining the indication of one or more desired safety factors in the block 405. Alternatively, the relative importance of the various indicated safety factors may be obtained and stored prior to the execution of the method 400, and the stored relative importance may be retrieved at the block 418. If no stored or real-time user input is available, a default relative importance amongst the range of the various indicated safety factors may be used. Similarly, if user input is available for only certain indicated safety factors, available user input may be used for weighting the certain indicated safety factors, with the remainder of the desired safety factors using a default weighting.

After the risk values for the indicated safety factors have been combined to determine the overall risk value for the route (block 422), the determined overall risk value may be provided (block 425). Finally, at a block 428, the method 400 may end.

In some embodiments of the method 400, the method 400 may be performed on a segment by segment basis to determine a segment safety factor for each route segment of a particular route, similar to as previously discussed for the methods 230 and 250. An overall safety factor for the entire particular route may be determined by combining the segment safety factors in some weighted or non-weighted manner. In this case, user preferences corresponding to indicated safety factors may differ between segments of the route. For example, a user may be less concerned with an availability of cell phone coverage or rest stops closer to the origin or destination of a route.

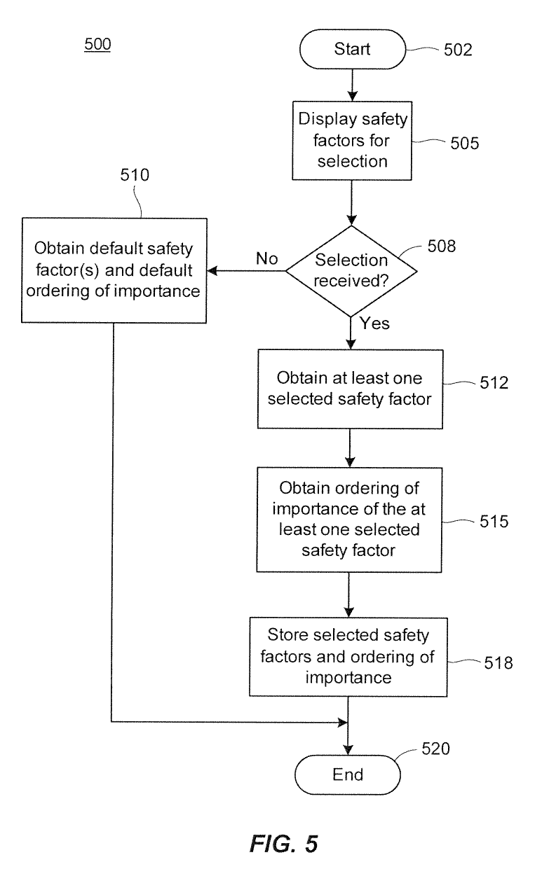

FIG. 5 illustrates an embodiment of a method 500 for obtaining user selections of safety factors and their relative importance. The method 500 may be used in conjunction with embodiments of the system 100 of FIG. 1A, the method 200 of FIG. 2A, the dependency chart 300 of FIG. 3, and/or the method 400 of FIG. 4.

At the start (block 502), the method 500 may display a range or list of safety factors for selection (block 505). The block 505 may display the range or list of selectable safety factors on a user interface /display mechanism of any known navigation or routing system platforms, such as embodiments of system 100 previously discussed with regard to FIG. 1A. For example, the block 505 may display the range of selectable safety factors on a web-based platform accessible via a browser, a locally installed applications on a local computer with an Internet connection, a personal navigation device (PND), or a web-based platform used in conjunction with a wireless client for user interface and display, among others.

A block 508 may determine if any safety factor selections are received. If no safety factor selections are received, then the method 500 may proceed to a block 510 where default safety factor selections and (optionally) a default ordering of importance of the default safety factor selections may be obtained. After obtaining the defaults, the method 500 may end (block 520).

If, at the block 508, one or more safety factor selections are received, then the method 500 may proceed to a block 512 to obtain the one or more selected safety factors. A block 515 may obtain an ordering of importance and/or a relative importance of each of the one or more selected safety factors. Note that the block 515 may be optional. If the block 515 is omitted, a default ordering of importance and/or a default relative importance of safety factors may be used.

A block 518 may store the obtained one or more safety factors. If the block 515 obtained the ordering of importance of the one or more safety factors, the ordering may also be stored at block 518. If no storage is desired, the block 518 may be optional. Finally, at the block 520, the method 500 may end.

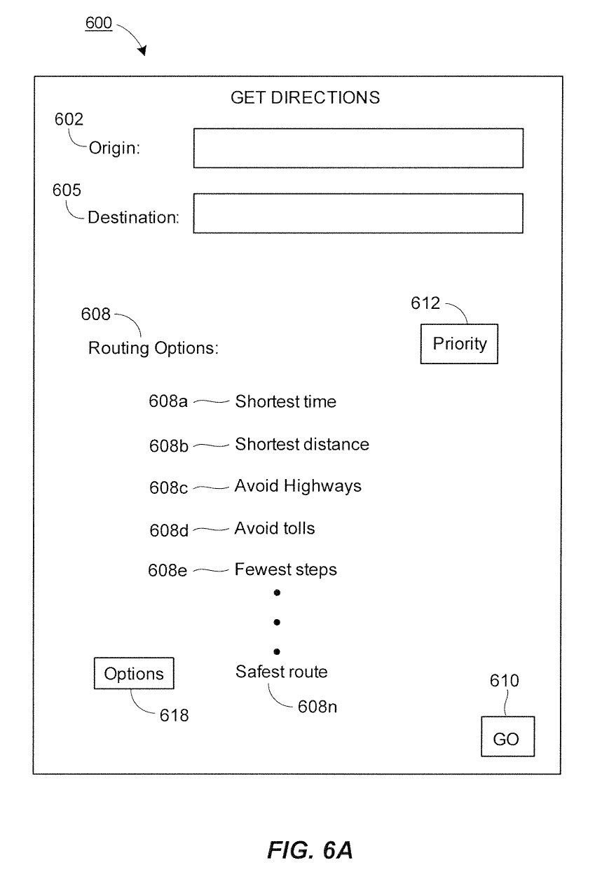

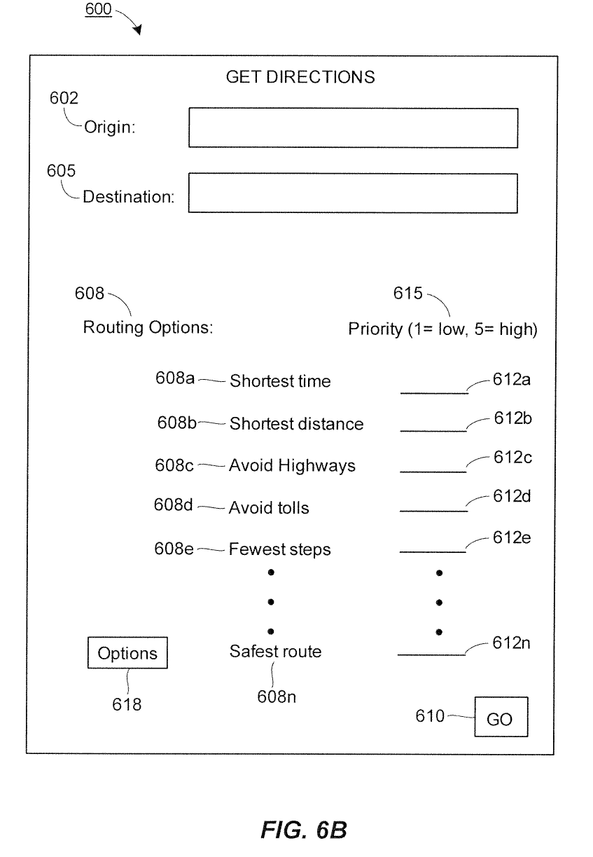

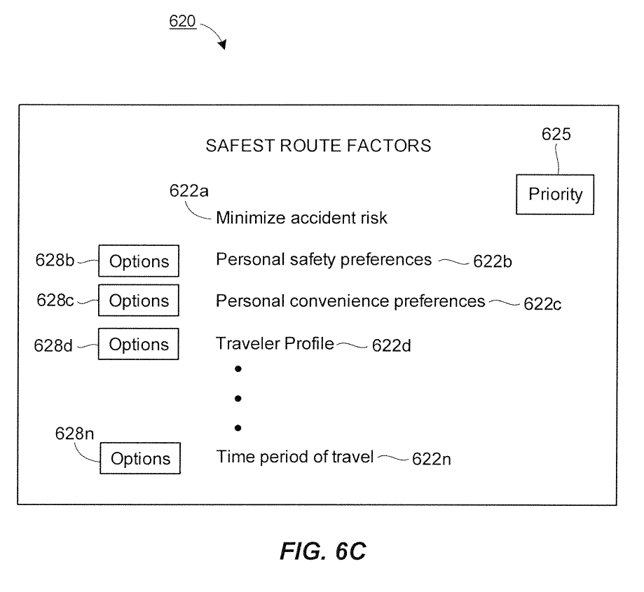

FIG. 6A illustrates an example of a possible user interface that may operate in accordance with the methods and systems of the present disclosure. A screen display 600 of FIG. 6A may be displayed on, for example, the user interface 105 of the system 100 of FIG. 1A and may be used by the methods 200, 400, and/or 500. Note that the format and exact layout of the screen 600 is not meant to be limiting, but merely illustrates one possible embodiment of a display screen presented via a user interface.

The screen 600 may be displayed to obtain user input regarding a route between an origin and a destination for which a user wishes to obtain directions. The screen 600 may contain fields typically used in navigation and routing systems, such as a field for entering a desired origin 602 and a field for entering a desired destination 605. The screen 600 may also indicate routing options 608. Selectable routing options 608a, 608b, 608c, 608d, 608e that are commonly used in navigation routing systems may be displayed, including options such as shortest time 608a, shortest distance 608b, avoidance of highways 608c, avoidance of tolls 608d, fewest number of instructions 608e, and the like. Also included on the screen 600 may be a “GO” button 610 or equivalent to indicate that the user has finished entering input and is ready for the system or program to find the requested route.

A selectable field for a safest route option 608n may be included in the list of selectable routing options. Each routing option 608a, 608b, 608c, 608d, 608e, . . . , 608n may be selected by, for instance, clicking on the button associated with the option, clicking on the name itself, or by some other means for obtaining the user selection.

The routing options 608a-n may have a selectable button 612 or other means for the user to indicate a desire to select priority amongst selected routing options 608a, 608b, 608c, 608d . . . 608n. In some embodiments, if the user clicks on the button 612, additional fields 612a, 612b, 612c, 612d, 612e, . . . , 612n corresponding to each available routing option may be added to the screen 600, as illustrated in FIG. 6B. A key 615 explaining how to indicate priority may also appear on the screen 600. In the example illustrated by FIG. 6B, a priority of routing options is indicated on a scale of 1 to 5, where 1 indicates lowest priority and 5 indicates highest priority. Other keys and/or scales for indicating priority may be used, such as a different range of numbers, letters, graphical icons, colors, and the like. The user may then enter a desired priority for each selected option 608a, 608b, 608c, 608d, 608e, . . . , 608n in a corresponding priority field 612a, 612b, 612c, 612d, 612e, . . . , 612n. Of course, the user may indicate that a particular routing option may have no priority or should not be considered in determining a possible route.

While FIG. 6B illustrates one embodiment for allowing the user to indicate priority selection by adding additional fields, other embodiments for allowing the user to indicate priority selection are also possible. For example, priorities may be indicated via drop-down menus, pop-up screens, or other means. Priorities of routing options may initially appear with pre-populated values that indicate the default settings.

Returning to FIG. 6A, a selectable options button 618 or other means may allow the user to select safety factors for the safest routing option selection 608n. For example, if the user clicks on options button 618, a screen 620 may be displayed, as illustrated in FIG. 6C. On the screen 620, a list of selectable safety factors corresponding to the safest routing option 608n may appear, including for example, minimization of accident risk 622a, personal safety preferences 622b, personal convenience preferences 622c, traveler profile 622d, time period of travel 622n, and other safety factors. Safety factors displayed on screen 620 may include, for example, any of the safety factors contained in embodiments of the dependency chart 300. Each selectable safety factor 622a, 622b, 622c, 622d, . . . 622n may be individually selectable by, for instance, clicking on a button associated with the option, clicking on the name itself, or by some other means for obtaining user selection.

Similar to the screen 600 of FIG. 6A, the screen 620 may also provide a priority indication button 625 or other means for the user to indicate a desire to prioritize amongst the selectable safety factors 622a, 622b, 622c, 622d, . . . 622n. When the user indicates a desire to prioritize the selectable safety factors via activating the button 625 or via other selection means, fields similar to 612a, 612b, 612c, 612d . . . 612n on screen 600 (not shown) and a key to priority similar to 615 on the screen 600 (not shown) may appear for safety factors 622a, 622b, 622c, 622d, . . . , 622n. Alternatively, other mechanisms may be used to indicate priority of safety factors, including drop down screens, pop-up screens, and/or other means. In some embodiments, a default priority of safety factors may initially appear when the button 625 is selected.

Similar to the function of options button 618 of FIG. 6A, any selectable safety route factor 622b, 622c, 622d, . . . , 622n that may require further user input may have a corresponding options button 628b, 628c, 628d, . . . , 628n. For example, if the user selects the personal safety preferences safety factor 622b, corresponding further user input may be entered by indicating the options button 628b. Upon activation of the options button 628b, a child screen for the screen 620 may be displayed containing a selectable list of personal safety preferences, such as area crime statistics, remoteness measure and other personal safety preferences (such as those discussed with regard to reference 340 of FIG. 3).

In another example, if the user selects the traveler profile safety factor 622d, an activation of the options button 628d may cause a child screen for the screen 620 to be displayed (not shown). The child screen corresponding to the traveler profile safety factor 622d may contain fields corresponding to traveler profile parameters to be filled in by the user, such as traveler age, traveler accessibility restrictions, and other traveler profile attributes (such as those discussed with regard to reference 312 of FIG. 3). Other option selection buttons 628c, . . . , 628n may operate in a similar fashion. Of course, a child screen is only one embodiment of conveying or obtaining the selectable information. Other embodiments of conveying or obtaining selectable detail may be used, including drop-down menus, text boxes, and the like.

Similar to the prioritization of the routing options 612 and the prioritization of the safety factors 625, priority amongst personal safety preferences and/or personal convenience preferences may be indicated by the user via a similar means (not shown).

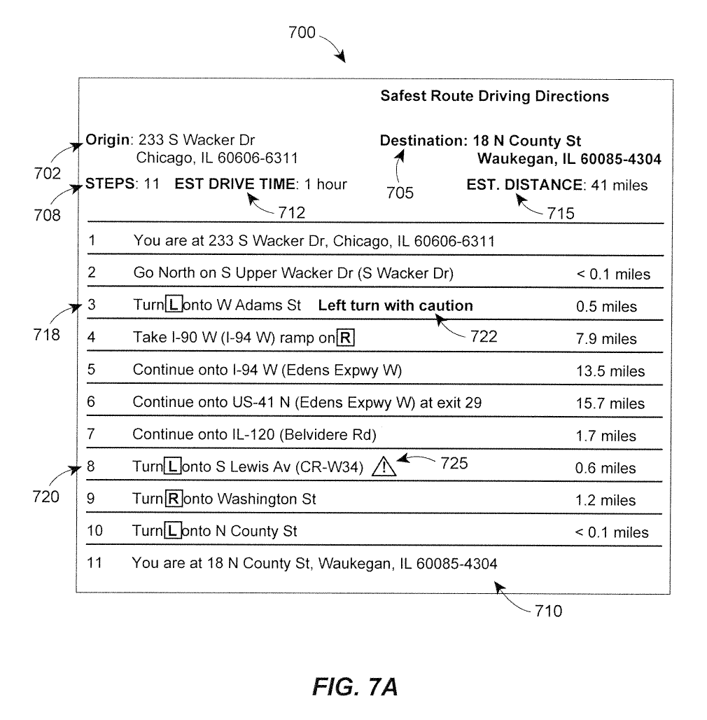

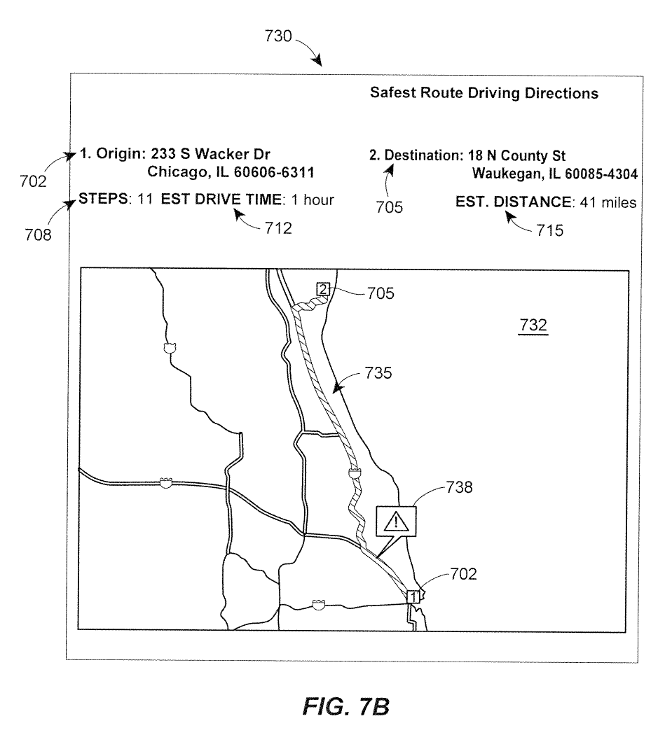

FIG. 7A depicts an exemplary display 700 exhibiting a determined safest route using a textual representation. The display 700 may be for example, produced by system 100 or by the methods 200, 400 and/or 500 described herein. The display 700 may indicate an origin 702 and a destination 705 of the determined safest route, a number of steps or instructions 708 in a direction set 710, an estimated travel time 712, and an estimated distance 715. The direction set 710 may include a list of ordered traveling instructions that may guide a traveler along the determined safest route. As optimal as the determined safest route may be, however, one or more portions along the determined safest route may still be inherently more risky than other portions of the determined safest route. For instance, a particular travel direction including a left turn after a blind intersection may be more risky than another travel direction including a straight stretch of interstate. Riskier portions of the determined safest route may be differentiated from other portions of the determined safest route on the display 700 so that the user may be alerted.

In the example shown in display 700, riskier portions of the determined safest route may be visually differentiated. Assume, in the example of display 700, that step 3 (reference 718) of the direction set 710 is riskier than most other steps of the direction set 710, and step 8 (reference 720) of the direction set 710 is even riskier than step 3. The relative level of risk of each step in the direction set 710 may be determined and compared to, for example, respective, corresponding risk values for each step that may be determined using the previously discussed methods of the disclosure. The higher level of risk of step 3 (reference 718) and step 8 (reference 720) may be indicated on display 700 via a different font, a different size, a different color, additional text (e.g., “LEFT TURN WITH CAUTION” as indicated by reference 722), a dynamic visual indicator (e.g., blinking, flashing, etc.), a graphical icon 725, or some other visual indicator. In some embodiments, gradations between varying risk levels may be indicated. For example, in an embodiment where risk levels are indicated by color-coding, step 3 (reference 718) may appear in yellow and step 8 (reference 720) may appear in red, while the other, safer instructions may appear in green. In some embodiments, more than one type of visual differentiation may be used.

Similarly, visual differentiation of riskier portions of the determined safest route may be used in a graphical representation of the determined safest route, such as illustrated in display 730 of FIG. 7B. In the display 730, the origin 702, destination 705, number of steps 708 in the direction set, estimated travel time 712 and estimated distance 715 may be indicated. Instead of a textual representation of the determined safest route as shown in the display 700, though, the display 730 may include a graphical or mapped representation 732 of the determined safest route. In the graphical representation 732, the actual determined safest route may be indicated by a highlighting or other visual indicator 735. Additionally, particularly riskier portions of the determined safest route may be further indicated, for example, via a different highlight color, a graphical icon 738, a dynamic visual indicator such as flashing the particularly riskier portions of the highlighted determined safest route, and the like. In some embodiments, a user on-focus event of the indication of particularly riskier portion (e.g., a mouse-over, a click, etc.) may result in additional detail being provided through additional pop-up text, a new window, or a zoomed-in view of the particularly riskier portion (not shown).

In some embodiments, riskier portions of the determined safest route may be differentiated via an auditory indication. For example, in an in-dash navigation system that provides auditory routing directions, the auditory routing directions may indicate a particularly risky maneuver, e.g., “Take care in making the sharp left turn ahead . . . ” or “Caution, four lanes merging into one lane in 50 yards . . . .” In some embodiments, a type of differentiating indicator for riskier portions of a determined safest route (visual, auditory, or otherwise) may be selectable. For example, the user may select a color-coded differentiation, or the user may select an additional textual warning differentiation.

Although the above describes example methods and systems including, among other components, software and/or firmware executed on hardware, it should be noted that these examples are merely illustrative and should not be considered as limiting. For example, it is contemplated that any or all of the hardware, software, and firmware components could be embodied exclusively in hardware, exclusively in software, or in any combination of hardware and software. Accordingly, while the following describes example methods and apparatus, persons of ordinary skill in the art will readily appreciate that the examples provided are not the only way to implement such methods and apparatus.

Although certain functions and features have been described herein in accordance with the teachings of the present disclosure, the scope of coverage of this disclosure is not limited thereto. To the contrary, this disclosure covers all embodiments of the teachings of the disclosure that fairly fall within the scope of permissible equivalents.

What is claimed is:

1. A method for determining a route between an origin and a destination comprising:
obtaining an indication of the origin and an indication of the destination;
obtaining a plurality of candidate routes between the origin and the destination, each of the candidate routes defining a geographical connection traversable by one or more modes of transportation between the origin and the destination;
determining a candidate risk value for each of the candidate routes, wherein the candidate risk value for a particular candidate route is based on at least one physical route attribute of the particular candidate route, the candidate risk value for the particular candidate route indicating a level of safety of the particular candidate route;
determining a safest route between the origin and the destination based on the candidate risk values for the candidate routes, the safest route being one of the candidate routes having a candidate risk value indicating a higher level of safety than another of the candidate routes; and
communicating the safest route to a user.

2. The method of claim 1, wherein determining a candidate risk value for the particular candidate route based on the at least one physical route attribute comprises determining the candidate risk value for the particular candidate route based on at least one physical route attribute selected from:
a geometrical attribute, a type of road, a lane width, a grade of road, a presence of a dedicated turn lane, a shoulder width, a number of passing opportunities, a presence of a divider, a presence of blind intersection, a sight distance of a curve, a presence of a controlled access, a length of an exit or an entrance ramp, a spacing of interchanges, a number of intersections, an angle of one of the number of intersections, a type of one of the number of intersections, a presence of a railroad crossing, a number of lanes, a presence of a recovery area, a vertical clearance, a horizontal clearance, a strength of a bridge, a composition of the at least one candidate route, a shoulder presence, a mix of route segments having differing numbers of lanes, an accessibility level for a traveler with an accessibility restriction, or a tunnel clearance, wherein the geometrical attribute comprises an attribute corresponding to a geometrical characteristic of a physical configuration of the particular candidate route.

3. The method of claim 1, wherein obtaining the plurality of candidate routes between the origin and the destination includes defining a geographical connection traversable by one or more modes of transportation selected from:
a vehicle classifiable by a governmental agency,
a personal transportation device,
a mode of public transportation,
a mode of transportation for use in water, or
an ambulation mode used by a pedestrian.

4. The method of claim 1, wherein determining the candidate risk value for the particular candidate route based on the at least one physical route attribute of the particular candidate route includes:
defining two or more route segments of the particular candidate route;
determining a segment candidate risk value for each route segment of the particular candidate route, wherein the segment candidate risk value for at least one particular route segment of the particular candidate route is based on the at least one physical route attribute of the particular route segment; and
aggregating the segment candidate risk values to obtain the candidate risk value for the particular candidate route.

5. The method of claim 4, wherein aggregating the segment candidate risk values includes determining a weighted sum of the segment candidate risk values.

6. The method of claim 1, wherein determining the candidate risk value for the particular candidate route comprises determining the candidate risk value as a cost aggregated over a distance associated with the particular candidate route that is inversely related to the level of safety of the particular candidate route, the cost being one of: fatalities per unit distance, accidents per unit distance, an actuarial monetary cost, or a time cost.

7. The method of claim 1, further comprising accessing map data, the map data including representations of the origin, the destination, and the geographical regions defining the plurality of candidate routes, and wherein determining the candidate risk value for the particular candidate route based on the at least one physical route attribute comprises determining the candidate risk value for the particular candidate route based on the at least one physical route attribute using the map data.

8. The method of claim 1, further comprising identifying a potential risky maneuver for the particular candidate route based on the at least one physical route attribute, and wherein determining the candidate risk value for the particular candidate route based on the at least one physical route attribute comprises determining the candidate risk value for the particular candidate route based on the at least one physical route attribute and the potential risky maneuver.

9. The method of claim 1, further comprising obtaining an indication of a time period during which the safest route is to be traversed, and wherein determining the candidate risk value for the particular candidate route comprises determining the candidate risk value for the particular candidate route based on the at least one physical route attribute and the time period.

10. The method of claim 1, further comprising obtaining at least one legal regulation corresponding to the particular candidate route, and wherein determining the candidate risk value for the particular candidate route includes determining the candidate risk value for the particular candidate route based on the at least one physical route attribute and the at least one legal regulation.

11. The method of claim 10, wherein obtaining the at least one legal regulation comprises obtaining a speed limit associated with the particular candidate route.

12. The method of claim 1, further comprising obtaining one or more desired modes of transportation, and wherein obtaining the plurality of candidate routes between the origin and the destination includes obtaining the plurality of candidate routes between the origin and the destination such that each of the candidate routes defines a geographical connection between the origin and the destination traversable using the one or more desired modes of transportation, and wherein determining the candidate risk value for the particular candidate route based on the at least one physical route attribute comprises determining the candidate risk value for the particular candidate route based on the at least one physical route attribute and the one or more desired modes of transportation.

13. The method of claim 12, further comprising obtaining a priority for each desired mode of transportation, and wherein determining the candidate risk value for the particular candidate route based on the at least one physical route attribute and the one or more desired modes of transportation comprises determining the candidate risk value for the particular candidate route further based on the priority for each desired mode of transportation.

14. The method of claim 1, further comprising obtaining statistical data associated with the particular candidate route, wherein determining the candidate risk value for the particular candidate route based on the at least one physical route attribute comprises determining the candidate risk value for the particular candidate route based on the at least one physical route attribute and the statistical data.

15. The method of claim 14, wherein obtaining the statistical data associated with the particular candidate route comprises obtaining statistical data associated with the particular candidate route including at least one of: fatality statistics, accident statistics, tickets issued statistics, topology statistics, weather statistics, climate statistics, traffic pattern statistics or vegetation statistics.

16. The method of claim 1, further comprising obtaining at least one personal safety preference, and wherein determining the candidate risk value for the particular candidate route based on the at least one physical route attribute comprises determining the candidate risk value for the particular candidate route based on the at least one physical route attribute and the at least one personal safety preference.

17. The method of claim 16, wherein obtaining the at least one personal safety preference comprises obtaining at least one personal safety preference from a group of personal safety preferences including:
wireless service coverage for a geographical area of the particular candidate route,
crime statistics for the geographical area,
a remoteness measure of the particular candidate route,
a proximity of the particular candidate route to a vehicle repair facility,
a quality of lighting along the particular candidate route, and
an indication of an existence of a hazardous breakdown locale along the particular candidate route.

18. The method of claim 17, wherein obtaining the remoteness measure of the particular candidate route corresponds to obtaining a density of Points of Interest (POIs) along the particular candidate route, and wherein obtaining the indication of the existence of the hazardous breakdown locale comprises obtaining an indication of a route segment of the particular candidate route with a narrow shoulder, a tunnel, a mountain road, or a bridge.

19. The method of claim 16, further comprising obtaining a priority for each of two or more personal safety preferences, and wherein determining the candidate risk value for the particular candidate route based on the at least one physical route attribute and the at least one personal safety preference comprises determining the candidate risk value further based on the priorities for the two or more personal safety preferences.

20. The method of claim 1, further comprising obtaining a profile of a traveler of the particular candidate route, and wherein determining the candidate risk value for the particular candidate route based on the at least one physical route attribute comprises determining the candidate risk value for the particular candidate route based on the at least one physical route attribute and the profile of the traveler.

21. The method of claim 20, wherein obtaining the profile of the traveler comprises obtaining at least one of a traveler age, a traveler experience with the one or more modes of transportation, or an indication of an accessibility limitation of the traveler.

22. The method of claim 1, further comprising obtaining at least one personal convenience preference, and wherein determining the candidate risk value for the particular candidate route based on the at least one physical route attribute comprises determining the candidate risk value for the particular candidate route based on the at least one physical route attribute and a proximity of the particular candidate route to the at least one personal convenience preference.

23. The method of claim 22, wherein obtaining the at least one personal convenience preference comprises obtaining at least one personal convenience preference selected from: a service station, a restaurant, a rest stop, a handicapped accessible facility, a retailer, or a vehicle dealership.

24. The method of claim 22, further comprising obtaining a priority for each of two or more personal convenience preferences, and wherein determining the candidate risk value for the particular candidate route based on the at least one physical route attribute comprises determining the candidate risk value for the particular candidate route further based on the priorities for the two or more personal convenience preferences.

25. The method of claim 1, wherein communicating the safest route comprises displaying the safest route via a browser interface.

26. The method of claim 1, wherein communicating the safest route comprises communicating the safest route with an indication of one or more riskier portions of the safest route using at least one of: a textual indication, a graphical indication, or an audio indication,
the one or more riskier portions of the safest route having a lower level of safety than other portions of the safest route.

27. The method of claim 26, wherein communicating the safest route with the indication of the one or more riskier portions of the safest route comprises communicating the safest route with an indication of the one or more riskier portions of the safest route using a color-code corresponding to a relative level of safety of the one or more riskier portions.

28. The method of claim 1, wherein communicating the safest route comprises communicating the safest route from a first computing device to a second computing device.

29. The method of claim 28, wherein communicating the safest route from the first computing device to the second computing device comprises communicating the safest route from one of a server or a peer node in a network to a second computing device in the network.

30. A method for determining a route between an origin and a destination, comprising:
obtaining an indication of the origin and an indication of the destination;
obtaining a plurality of candidate routes between the origin and the destination, each of the candidate routes defining a geographical connection traversable by one or more modes of transportation between the origin and the destination;
determining a candidate risk value for each of the candidate routes, wherein the candidate risk value for a particular candidate route is based on at least one personal safety preference, the candidate risk value for the particular candidate route indicating a level of safety of the particular candidate route;
determining a safest route between the origin and the destination based on the candidate risk values for the candidate routes, the safest route being one of the candidate routes having a candidate risk value indicating a higher level of safety than another of the candidate routes; and
communicating the safest route to a user.

31. The method of claim 30, wherein determining the candidate risk value for the particular candidate route based on the at least one personal safety preference comprises determining the candidate risk value for the particular candidate route based on at least one from a group of personal safety preferences including:
wireless service coverage for a geographical area of the particular candidate route,
crime statistics for the geographical area,
a remoteness measure of the particular candidate route,
a proximity of the particular candidate route to a vehicle repair facility,
a quality of lighting along the particular candidate route, and
an indication of an existence of a hazardous breakdown locale along the particular candidate route.

32. The method of claim 30, further comprising obtaining a priority for each of two or more personal safety preferences, and wherein determining the candidate risk value for the particular candidate route based on the at least one personal safety preference comprises determining the candidate risk value based on the two or more personal safety preferences and further based on the priorities of the two or more personal safety preferences.

33. The method of claim 30, wherein determining the candidate risk value for the particular candidate route based on the at least one personal safety preference includes defining two or more route segments associated with the particular candidate route, determining a segment candidate risk value for each route segment of the particular candidate route, wherein the segment candidate risk value for a particular route segment of the particular candidate route is based on the at least one personal safety preference associated with the particular route segment and aggregating the segment candidate risk values to obtain the candidate risk value for the particular candidate route.

34. The method of claim 30, further comprising accessing map data, the map data including representations of the origin, the destination, and geographical regions defining the plurality of candidate routes, and wherein determining the candidate risk value for the particular candidate route based on the at least one personal safety preference comprises determining the candidate risk value for the particular candidate route based on the at least one personal safety preference using the map data.

35. The method of claim 30, further comprising obtaining an indication of a time period during which the safest route is to be traversed, and wherein determining the candidate risk value for the particular candidate route comprises determining the candidate risk value for the particular candidate route based on the at least one personal safety preference and the time period.

36. The method of claim 30, further comprising obtaining a profile of a traveler of the particular candidate route, and wherein determining the candidate risk value for the particular candidate route based on the at least one personal safety preference comprises determining the candidate risk value for the particular candidate route based on the at least one personal safety preference and the profile of the traveler.

37. The method of claim 30, further comprising obtaining at least one personal convenience preference, and wherein determining the candidate risk value for the particular candidate route based on the at least one personal safety preference comprises determining the candidate risk value for the particular candidate route based on the at least one personal safety preference and a proximity of the particular candidate route to the at least one personal convenience preference.

38. A method for determining a route between an origin and a destination, comprising:
obtaining an indication of the origin and an indication of the destination;
obtaining a plurality of candidate routes between the origin and the destination, each of the candidate routes defining a geographical connection traversable by one or more modes of transportation between the origin and the destination;
determining a candidate risk value for each of the candidate routes, wherein the candidate risk value for a particular candidate route is based on a proximity of the particular candidate route to at least one personal convenience preference, the candidate risk value for the particular candidate route indicating a level of safety of the particular candidate route;
determining a safest route between the origin and the destination based on the candidate risk values for the candidate routes, the safest route being one of the candidate routes having a candidate risk value indicating a higher level of safety than another of the candidate routes; and
communicating the safest route to a user.

39. The method of claim 38, wherein determining the candidate risk value for the particular candidate route based on the proximity of the particular candidate route to the at least one personal convenience preference comprises determining the candidate risk value for the particular candidate route based on a proximity of the particular candidate route to at least one personal convenience preference selected from: a service station, a restaurant, a rest stop, a handicapped accessible facility, a retailer, or a vehicle dealership.

40. The method of claim 39, further comprising obtaining a priority for each of two or more personal convenience preferences, and wherein determining the candidate risk value for the particular candidate route based on the proximity of the particular candidate route to the at least one personal convenience preference comprises determining the candidate risk value for the particular candidate route based on the proximity of the particular candidate route to the two or more personal convenience preferences and further based on the priorities for the two or more personal convenience preferences.

41. The method of claim 38, wherein determining the candidate risk value for the particular candidate route based on the proximity of the particular candidate route to the at least one personal convenience preference includes:
defining two or more route segments associated with the particular candidate route;
determining a segment candidate risk value for each route segment of the particular candidate route, wherein the segment candidate risk value for a particular route segment of the particular candidate route is based on a proximity of the particular route segment to the at least one personal convenience preference; and
aggregating the segment candidate risk values to obtain the candidate risk value for the particular candidate route.

42. The method of claim 38, further comprising accessing map data, the map data including representations of the origin, the destination, and geographical regions defining the plurality of candidate routes, and wherein determining the candidate risk value for the particular candidate route based on the proximity of the particular candidate route to the at least one personal convenience preference comprises determining the candidate risk value for the particular candidate route based on the proximity of the particular candidate route to the at least one personal convenience preference using the map data.

43. The method of claim 38, further comprising obtaining an indication of a time period during which the safest route is to be traversed, and wherein determining the candidate risk value for the particular candidate route based on the proximity of the particular candidate route to the at least one personal convenience preference comprises determining the candidate risk value for the particular candidate route based on the proximity of the particular candidate route to the at least one personal convenience preference and the time period.

44. The method of claim 38, further comprising obtaining a profile of a traveler of the particular candidate route, and wherein determining the candidate risk value for the particular candidate route based on the proximity of the particular candidate route to the at least one personal comprises preference comprises determining the candidate risk value for the particular candidate route further based the profile of the traveler.

45. A route evaluation system comprising:
a processor operatively coupled to a memory;
a database accessible by the processor and including map data;
a display operatively coupled to the processor;
a first routine stored in the memory and executable by the processor and arranged to direct the processor to obtain a first route and at least one other route from an origin to a destination based on the map data, the first and the at least one other route each defining a geographical connection traversable by one or more modes of transportation between the origin and the destination;
a second routine stored in the memory and executable by the processor and arranged to direct the processor to obtain at least one safety factor from a group of safety factors including an accident risk factor, a personal safety preference and a personal convenience preference;
a third routine stored in the memory and executable by the processor and arranged to direct the processor to:
determine a first risk value for the first route based on the at least one safety factor, the first risk value indicating a level of safety for the first route, and
determine an at least one other risk value for the at least one other route based on the at least one safety factor, the at least one other risk value indicating a level of safety for the at least one other route;
a fourth routine stored in the memory and executable by the processor and arranged to direct the processor to determine a safest route between the origin and the destination based on a comparison of the first risk value and the at least one other risk value, the safest route having a risk value indicating a higher level of safety; and
a fifth routine stored in the memory and executable by the processor and arranged to direct the processor to exhibit the safest route on the display.

46. The route evaluation system of claim 45, wherein the map data includes an indication of a first set of contiguous route segments for the first route, and an indication of an at least one other set of contiguous route segments for the at least one other route; and wherein the third routine is arranged to direct the processor to determine a first segment risk value for each member of the first set of contiguous route segments, the first segment risk value based on the at least one safety factor corresponding to the each member of the first set, determine an at least one other segment risk value for each member of the at least one other set of contiguous route segments, the at least one other segment risk value based on the at least one safety factor corresponding to the each member of the at least one other set, determine the first risk value based on an aggregation of the first segment risk values corresponding to the members of the first set, and determine the at least one other risk value based on an aggregation of the at least one other segment risk values corresponding to the members of the at least one other set.

47. The route evaluation system of claim 45, further comprising a selection routine, the selection routine stored in the memory, executable by the processor, and arranged to direct the processor to exhibit, for selection, the group of safety factors on the display and to receive at least one selected safety factor from the group of safety factors, and wherein the second routine is arranged to direct the processor to obtain the at least one selected safety factor.

48. The route evaluation system of claim 45, wherein the second routine is arranged to direct the processor to obtain the accident risk factor, and wherein the third routine is arranged to direct the processor to determine, using the map data, the first and the at least one other risk values based on at least one physical route attribute of each of the first and the at least one other routes, respectively, the at least one physical route attribute selected from a group of physical route attributes comprising:
a geometrical attribute comprising a geometrical characteristic corresponding to a physical configuration, a type of road, a lane width, a grade of road, a presence of a dedicated turn lane, a shoulder width, a number of passing opportunities, a presence of a divider, a presence of blind intersection, a sight distance of a curve, a presence of a controlled access, a length of an exit or an entrance ramp, a spacing of interchanges, a number of intersections, an angle of one of the number of intersections, a type of one of the number of intersections, a presence of a railroad crossing, a number of lanes, a presence of a recovery area, a vertical clearance, a horizontal clearance, a strength of a bridge, a composition of the first and the at least one other routes, a shoulder presence, a mix of route segments having differing numbers of lanes, an accessibility level for a traveler with an accessibility restriction, and a tunnel clearance.

49. The route evaluation system of claim 45, further comprising a priority routine, the priority routine stored in the memory, executable by the processor, and arranged to direct the processor to obtain an indication of a priority of at least two safety factors, wherein the second routine is arranged to obtain the at least two safety factors, and wherein the third routine is arranged to direct the processor to determine the first and the at least one other risk values further based on the priority of the at least two safety factors.

50. The route evaluation system of claim 45, wherein the database is remotely located from the processor.

51. The route evaluation system of claim 45, wherein the processor and the display are located on different computing devices, the different computing devices communicate over a network, and the safest route is exhibited on the display via a browser.

52. The route evaluation system of claim 51, wherein each of the different computing devices is linked to the network via at least one of a wireless or wired connection.

53. The route evaluation system of claim 45, wherein the processor includes a first processing device and a second processing device, wherein at least one of the first through fifth routines is stored in a memory of the first processing device and another one of the first through fifth routines different from the at least one of the first through fifth routines stored in the memory of the first processing device is stored in a memory of the second processing device, wherein the first and second processing devices are located on different computing devices, and wherein the different computing devices communicate over a network.

54. The route evaluation system of claim 53, wherein the network is at least partially a public network.

55. The route evaluation system of claim 45, wherein the processor is a processor of a personal portable navigation device.

56. The route evaluation system of claim 45, further comprising a risk differentiation routine, the risk differentiation routine stored in the memory, executable by the processor, and arranged to direct the processor to differentiate, on the display, one or more riskier portions of the safest route from other portions of the safest route, the one or more riskier portions of the safest route having a lower level of safety than the other portions of the safest route.

57. The route evaluation system of claim 56, wherein the risk differentiation routine is arranged to direct the processor to differentiate, on the display, the one or more riskier portions of the safest route by at least one of: a textual indication, a graphical indication, or an audio indication.

58. A method of determining a multi-modal route between an origin and a destination, comprising:
obtaining an indication of the origin and the destination;
obtaining a plurality of candidate routes between the origin and the destination, each of the candidate routes defining a geographical connection traversable by one or modes of transportation between the origin and the destination, wherein at least a portion of one candidate route is traversable by at least two different modes of transportation;
determining a candidate risk value for each of the candidate routes, wherein the candidate risk value for a particular candidate route is based on at least one safety factor for the particular candidate route, the candidate risk value for the particular candidate route indicating a level of safety of the particular candidate route, and wherein the one candidate route having the at least one portion traversable by the at least two different modes of transportation has a different candidate risk value corresponding to each of the at least two different modes of transportation;
determining a safest multi-modal route between the origin and the destination based on the candidate risk values for the candidate routes, the safest multi-modal route having a candidate risk value indicating a higher level of safety than another of the candidate routes; and
communicating the safest multi-modal route to a user.

59. The method of claim 58, further comprising obtaining an indication of a priority of each of the at least two different modes of transportation and wherein determining the candidate risk value for a particular candidate route is further based on the priorities of the at least two different modes of transportation.

60. The method of claim 58, wherein the at least two different modes of transportation are selected from: a vehicle classifiable by a governmental agency, a personal transportation device, a mode of public transportation, a mode of transportation for use in water, or an ambulation mode used by a pedestrian.

61. The method of claim 58, wherein determining the candidate risk value for the particular candidate route based on the at least one safety factor comprises determining the candidate risk value for the particular candidate route based on at least one safety factor selected from a group of safety factors including:
an accident risk factor based on at least one of map data and statistical data;
one or more personal safety preferences of the user;
one or more personal convenience preferences of the user;
a profile of a traveler including at least one of a traveler age, a traveler experience with each of the at least two different modes of transportation, or an indication of an accessibility restriction of the traveler; or
one or more legal regulations associated with the each at least one candidate route.

62. The method of claim 58, wherein determining the candidate risk value for the particular candidate route based on the at least one safety factor comprises determining the candidate risk value for the particular candidate route further based on at least one of a time period during which the safest multi-modal route is to be traveled or statistical data associated with the particular candidate route.

63. The method of claim 62, wherein determining the candidate risk value for the particular candidate route further based on the statistical data associated with the particular candidate route comprises determining the candidate risk value for the particular candidate route further based on at least one statistical data type associated with the particular candidate route selected from: crime statistics, statistical traffic patterns, an availability of a specific mode of transportation, or weather data.

64. The method of claim 58, wherein determining the candidate risk value for the particular candidate route based on the at least one safety factor includes:
defining two or more route segments associated with the particular candidate route;
determining a segment candidate risk value for each defined two or more route segments of the particular candidate route, wherein the segment candidate risk value for a particular route segment associated with the particular candidate route is based on the at least one safety factor associated with the particular route segment; and
aggregating the segment candidate risk values to obtain the candidate risk value for the particular candidate route.
